(19) United States
(12) Patent Application Publication
(10) Pub. No.: US 2011/0093898 A1
(43) Pub. Date: Apr. 21, 2011

(54) PROGRAM GUIDE SYSTEM WITH USER DESIGNATED FAVORITE THEMES

(76) Inventors: Joshua A. Rosenthol, East Norriton, PA (US); W. Benjamin Herrington, Tulsa, OK (US); Michael D. Ellis, Boulder, CO (US)

(21) Appl. No.: 12/884,703

(22) Filed: Sep. 17, 2010

Related U.S. Application Data
(63) Continuation of application No. 09/262,658, filed on Mar. 4, 1999, now abandoned.
(60) Provisional application No. 60/089,730, filed on Jun. 18, 1998.

(51) Int. Cl. H04N 5/445

(52) U.S. Cl. 725/46

(57) ABSTRACT

An interactive television program guide system is provided in which a user may inform a program guide of the user's interests. The interactive program guide system displays a list of available programming themes. The user may select a programming theme from the available programming themes and designate a level of interest in that theme. The user may designate, e.g., a high level of interest, i.e., a “favorite,” or a low level of interest in the theme. The programming guide will modify a list of themes according to the selected theme and level of user interest. The user is thus able to view the themes list and quickly identify programs of interest by the location of the selected theme in the themes list, or by a distinctive display of the selected theme.

### CROSS-REFERENCE TO RELATED APPLICATIONS

This application is a continuation of co-pending U.S. patent application Ser. No. 09/262,658, filed Mar. 4, 1999, which claims the benefit of U.S. provisional application No. 60/089,730, filed Jun. 18, 1998, each of which is incorporated herein by reference as though set forth in full.

### BACKGROUND OF THE INVENTION

This invention relates to interactive television program guides, and more particularly, to television program guides in which users may select particular subsets of programming by theme or genre.

Cable, satellites, and broadcast television systems provide users with a large number of television channels. Users have traditionally consulted printed television program schedules to determine the programs being broadcast at a particular time. More recently, interactive electronic television program guides have been developed that allow television program information to be displayed on a user's television.

Interactive program guides are typically implemented on set-top boxes. Such program guides allow users to view television program listings in different display formats. For example, a user may instruct the program guide to display a grid or table of program listings organized in a channel-ordered or a time-ordered list. Users may also search and sort program listings by genre (e.g., movies, sports, etc.) or by title (i.e., alphabetically). A user may obtain additional information for a program by placing a highlight region on a desired program listing and pressing an “info” button. The user may purchase a pay program from the program guide by placing the highlight region on a program listing and pressing an “OK” button. Some systems allow the user to select a program for recording by placing the highlight region on a program listing and pressing a “record” button.

Because there are so many television channels available, particularly with cable and satellite television systems, television program guides have been developed that allow users to select favorite channels. During tuning, the program guide may allow the user to tune to favorite channels only, while skipping all other channels. Alternatively, the table of program listings may be displayed to reflect the favorite channels. For example, the table of program listings may display only the favorite channels and suppress all other channels from view. According to another approach, all channels are displayed. However, when the user scans through the table of program listings, the cursor control, which highlights a program and allows the user to make a selection, will advance among the favorite channels and skip over the other channels.

Another approach to assist the user to select among the television channels available is allow users to select themes. It is desirable to have as many themes as possible to increase the likelihood of matching the viewer's interests. However, the list of themes may be consequently quite long, making it cumbersome for a viewer to find the desired programs. The user is often required to scroll through long lists of themes to find the desired theme.

Some program guides address this abundance of information by having hierarchical categories. First, the user is presented with a relatively short list of higher level categories. The user selects a higher level category. Subsequently, the program guide displays a list of subcategories, from which the user may select one or more subcategories. This process may continue through several levels of subcategorization. This organization structure has several disadvantages as well. While the list of themes at each level may be relatively short and easier to view, a drawback is that the user may not readily appreciate which high level category will lead to a desired specific theme at a lower level. The user may be required to enter multiple keystrokes to find the desired theme.

After such searching with either display method, the user may eventually locate the desired theme after a tedious process, and discover that the program guide does not have any program listings for the desired theme. Moreover, the user is required to repeat this process whenever a search by specific theme is desired.

What is needed is a more sophisticated way in which a user may inform a program guide of the user's theme preferences, so that the program guide can display programming themes in a more useful manner.

It is therefore an object of the present invention to provide an interactive program guide system in which the user may designate certain themes as favorites.

It is also an object of the invention to provide program listings which display programming having the user's favorite themes.

### SUMMARY OF THE INVENTION

These and other objects of the invention are accomplished in accordance with the principles of the present invention by providing an interactive television program guide system in which an interactive television program guide is at least partially implemented on user equipment of a user. In a client-server architecture, the program guide may also be implemented on a server located at a television distribution facility. The user equipment may be user television equipment or user personal computer equipment. The program guide displays a list of programming themes, and provides an option with the interactive program guide for the user to select a programming theme from the list of programming themes and a level of interest in that theme that is indicative of the user's television programming interests. The program guide may also provide a means for modifying the list of programming themes based on the selected programming theme and level of user interest. In one embodiment, the interactive television program guide provides an option for the user to select a programming theme as a favorite, i.e., indicative of a generally high level of user interest. The interactive television program guide may also be modified to display the selected programming theme at the top of the list of programming themes and shift the remaining programming themes lower in the list. The interactive program guide may also have means for providing an option to select a programming theme from the list of themes as a search criterion for searching the program listings data. In addition, means may be provided for displaying a list of programming having the theme selected as a search criterion.

In another embodiment, the interactive television program guide provides an option for the user to select a programming theme with a low level of user interest. The implementation of the interactive television program guide system may also provide several options for the display of the selected theme. According to one option, the program guide may be implemented to display the selected programming theme at the bottom of the list of programming themes. According to another option, the program guide may be implemented to suppress the selected theme from the list of themes. The suppressed themes may be subsequently restored to the themes list, if desired.

In another preferred embodiment, the interactive television program guide system is implemented to provide an option to selectively increment the position of the selected theme in the themes list. For example, the program guide may permit the user to numerically designate the position of the selected theme in the themes list.

In yet another preferred embodiment, the interactive television program guide system is implemented to display a list of programming themes and to provide an option to select a plurality of programming themes as favorites. The means for modifying the list of themes includes means for displaying the selected favorites in a distinctive manner, such as a predetermined color or with an icon or label designation. Moreover, the interactive program guide system provides means for providing an option to designate the selected themes as search criteria for searching the programming listings data.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of a system in which an interactive television program guide is implemented in accordance with the present invention.

FIG. 2 is a flow chart of steps involved in providing options to the user for selecting various display and search criteria in accordance with the present invention.

FIG. 3 is an illustrative interactive screen for displaying themes and selecting display options in accordance with the present invention.

FIG. 4 is a flow chart of steps involved in providing options for selecting display configurations in accordance with the present invention.

FIG. 5 is an illustrative interactive screen similar to FIG. 3, depicting a modified display configuration in accordance with the present invention.

FIG. 6 is a flow chart of steps involved in selecting search criteria and searching the programming listings data.

FIG. 7 is a flow chart of steps involved in organizing themes information in a preference profile.

FIG. 8(a) is an illustrative by-time program listings display in accordance with the present invention.

FIG. 8(b) is an alternative embodiment of an illustrative by-time program listings display in accordance with the present invention.

FIG. 9 is a flow chart, similar to FIG. 4, of steps involved in providing options to the user for selecting various display and search criteria in accordance with an alternative embodiment of the present invention.

FIG. 10 is a flow chart illustrating further steps involved in providing options for selecting display configurations in accordance with the present invention.

FIG. 11 is an illustrative screen for selecting display options in accordance with the present invention.

FIG. 12 is an illustrative interactive screen, similar to FIG. 3, for displaying themes and selecting display options in accordance with an alternative embodiment of the present invention.

FIG. 13 is a flow chart illustrating further steps involved in providing options for selecting display configurations in accordance with the present invention.

FIG. 14 is an alternative embodiment of an illustrative screen, similar to FIG. 12, for displaying themes and selecting display options in accordance with the present invention.

FIG. 15 is another flow chart illustrating further steps involved in providing options for selecting display configurations in accordance with the present invention.

FIG. 16 is an illustrative interactive screen for displaying themes and selecting display options in accordance with another alternative embodiment of the present invention.

FIG. 17 is an illustrative interactive screen for displaying themes and selecting display options in accordance with yet another alternative embodiment of the present invention.

FIG. 18 is an illustrative interactive screen for displaying favorite themes and selecting display options according to the present invention.

### DETAILED DESCRIPTION OF THE PREFERRED EMBODIMENTS

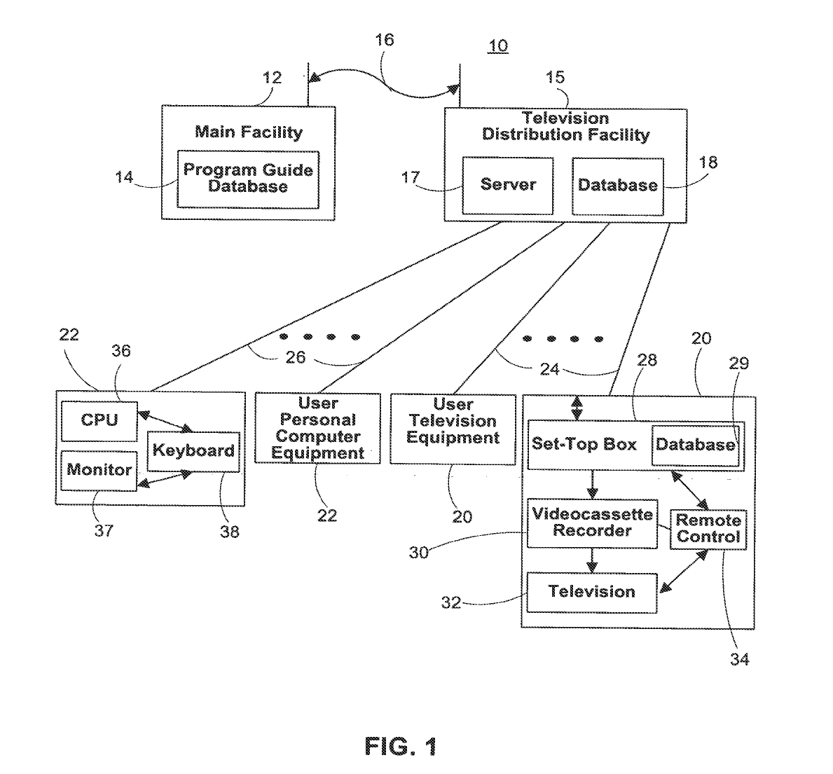

An illustrative program guide system 10 in accordance with the present invention is shown in FIG. 1. Main facility 12 contains a program guide database 14 for storing program guide information such as television program guide listings data, pay-per-view ordering information, television program promotional information, etc. Information from database 14 may be transmitted to television distribution facility 15 via communications link 16. Link 16 may be a satellite link, a telephone network link, a cable or fiber optic link, a microwave link, a combination of such links, or any other suitable communications path. If it is desired to transmit video signals over link 16 in addition to data signals, a relatively high bandwidth link such as a satellite link is generally preferable to a relatively low bandwidth link such as a telephone line.

Television distribution facility 15 is a facility for distributing television signals to users. Television distribution facility 15 may be, for example, a cable system headend, a broadcast distribution facility, a satellite television distribution facility, or any other distribution facility.

The program guide information transmitted by main facility 12 to television distribution facility 15 includes television program listings data for current and future television programs. The television program listings data for each program preferably includes numerous program characteristics, e.g., the title of the program, the channel for the program, a scheduled broadcast time (start time) and an ending time (or duration). Other typical program characteristics include ratings, critics ratings, descriptions, themes (sports, movies, comedy, children, etc.), actors, etc. Transmitted program information may also include advertising information and pay program data such as pricing information for individual programs and subscription channels, time windows for ordering programs and channels, telephone numbers for placing orders that cannot be impulse ordered, etc.

Television distribution facility 15 distributes television programming and program guide information to the user television equipment 20 or the user personal computer (PC) equipment 22 of multiple users via communications paths 24 and 26, respectively. For example, television programming may be distributed over analog television channels and program guide data may be distributed over an out-of-band channel on paths 24. Data distribution may also involve using one or more digital channels on paths 24 and 26. Such digital channels may also be used for distributing television programming and other information. Multiple television and audio channels (analog, digital, or both analog and digital) may be provided to set-top boxes 28 via communications paths 24. Program listings and other information may be distributed via communications path 26 to PC equipment 22. In addition, program listings and other data may also be distributed by one or more distribution facilities that are similar to but separate from television distribution facility 15 using communications paths that are separate from communications paths 24. If desired, data from the main facility 12 may be distributed to PC equipment 22 over the Internet or other suitable communications path that does not involve the use of television distribution facility 15.

The program guide may be implemented using a client-server architecture. In a client-server arrangement, the program guide is partially implemented on a server and partially implemented on a client. The server may be a server such as server 17 located at, for example, the television distribution facility 15, or alternatively, at the main facility 12. User equipment, e.g., set top box 28 or CPU 36, may act as the client processor. Program guide data that are distributed to a client-server program guide at television distribution facility 15 may be stored in a database 18 at television distribution facility 15. For clarity, the present invention is sometimes described primarily in the context of program guides that are implemented on user equipment, rather than in the context of program guides that are implemented partially on a server and partially on user equipment.

Certain functions such as pay program purchasing may require set-top boxes 28 to transmit data to television distribution facility 15 over communications paths 24. If desired, such data may be transmitted over telephone lines or other separate communications paths. If functions such as these are provided using facilities separate from television distribution facility 15, some of the communications involving set-top boxes 28 may be made directly with the separate facilities.

User television equipment 20 has a receiver, which is typically a set-top box such as set-top box 28, but which may be other suitable television equipment into which circuitry similar to set-top-box circuitry has been integrated. Program guide data may be distributed to set-top boxes 28 periodically or continuously and stored in database 29. In a client-server architecture, this database need not be maintained on the set-top box. For example, the program guide may maintain a database such as database 18 on a server such as server 17 located at television distribution facility 15 or some other appropriate location or locations. Television distribution facility 15 may poll set-top boxes 28 periodically for certain information (e.g., pay program account information or information regarding programs that have been purchased and viewed using locally-generated authorization techniques).

Main facility 12 preferably contains a processor to handle information distribution tasks. Each set-top box 28 preferably contains a processor to handle tasks associated with implementing a program guide application on the set-top box 28. Television distribution facility 15 may contain a processor for tasks associated with monitoring a user's interactions with the interactive program guide implemented on set-top boxes 28 and for handling tasks associated with the distribution of program guide data and other information to user television equipment 20. Moreover, the processor of television distribution facility 15 may implement the server functions of a client-server program guide.

Each set-top box 28 is typically connected to an optional videocassette recorder 30 so that selected television programs may be recorded. Each videocassette recorder 30 is connected to a television 32. To record a program, set-top box 28 tunes to a particular channel and sends control signals to videocassette recorder 30 (e.g., using an infrared transmitter) that direct videocassette recorder 30 to start and stop recording at the appropriate times.

During use of the interactive television program guide implemented on set-top box 28, television program listings and other information may be displayed on television 32. Such program guide displays may be presented on top of a television program to which the user has tuned with set-top box 28 or may be presented in place of such a program. Each set-top box 28, videocassette recorder 30, and television 32 may be controlled by one or more remote controls 34 or any other suitable user input interface such as a wireless keyboard, mouse, trackball, dedicated set of buttons, etc. Remote controls such as remote control 34 have various buttons that may be pressed by the user such as cursor keys (for on-screen movement of a highlight region, scrolling functions, etc.), an OK or select or enter key (for making a selection), channel number keys (for selecting a television channel), a favorites key (to invoke functions related to user preferences), a delete key (to delete menu items or to express a disinterest in certain user preferences), etc.

PC equipment, such as PC equipment 22 having CPU 36, may be used with the interactive program guide. The program guide may be used to access and display the program guide information on the PC monitor 37. User selections and inputs may be made by a keyboard 38, mouse, trackball, or other PC input devices. It is understood that the following discussion, although directed to user television equipment and set top boxes, is applicable to program guides used in connection with PC equipment.

Modern cable and satellite systems provide users with a wide range of programming, of which only a portion may be of interest to a user at a particular time. In order to locate program listings of interest, program guides typically allow users to search through the listings by programming theme. Typical themes, which are also sometimes called categories or genres, include, e.g., sports, children's programming, news, comedy, movies, etc. In accordance with the present invention, the program guide implemented on user television equipment 20 or PC equipment 22, allows users to designate certain themes as favorites in order to more efficiently search for programming that the user has an interest in. As described above, program listings data provides various program characteristics, such as program title, program theme (genre or category), etc. If the user has designated particular program themes as favorites, the favorite themes may be used to search for program listings of interest to the user. The program guide may also provide a list of themes in which the user's favorite themes appear at the top of the list.

The program guide provides various options that allow the user to specify favorite themes. Such options may be provided in the form of clickable menu items, drop-down lists, or any other suitable format. The user may select a desired menu item using a highlight region, cursor, arrow, or other suitable on-screen indicator that may be positioned over an option on the display (i.e., television 32). For example, a user may position a highlight region over a desired menu item and press OK on remote control 34 to complete the selection. Selections that involve entering characters may be made by selecting characters from characters displayed on the screen (e.g., using cursors to move through the alphabet) or by using a wireless keyboard or other alphanumeric entry device.

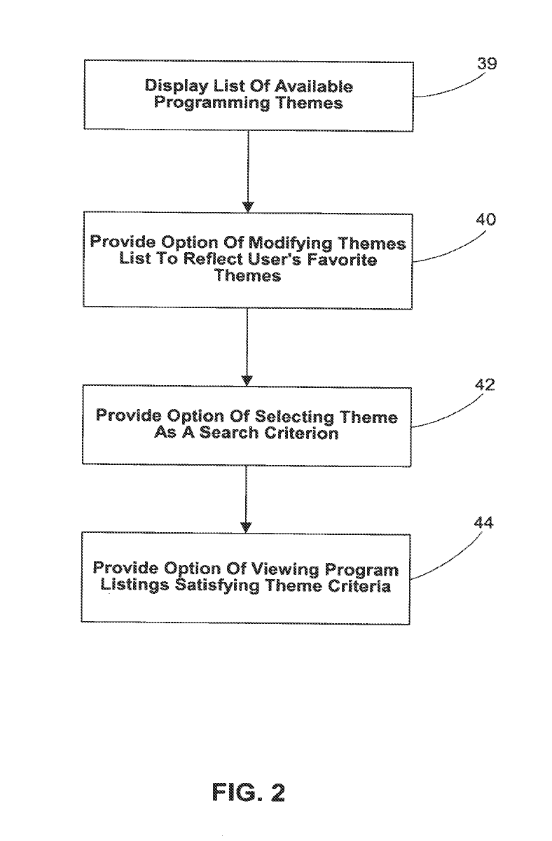

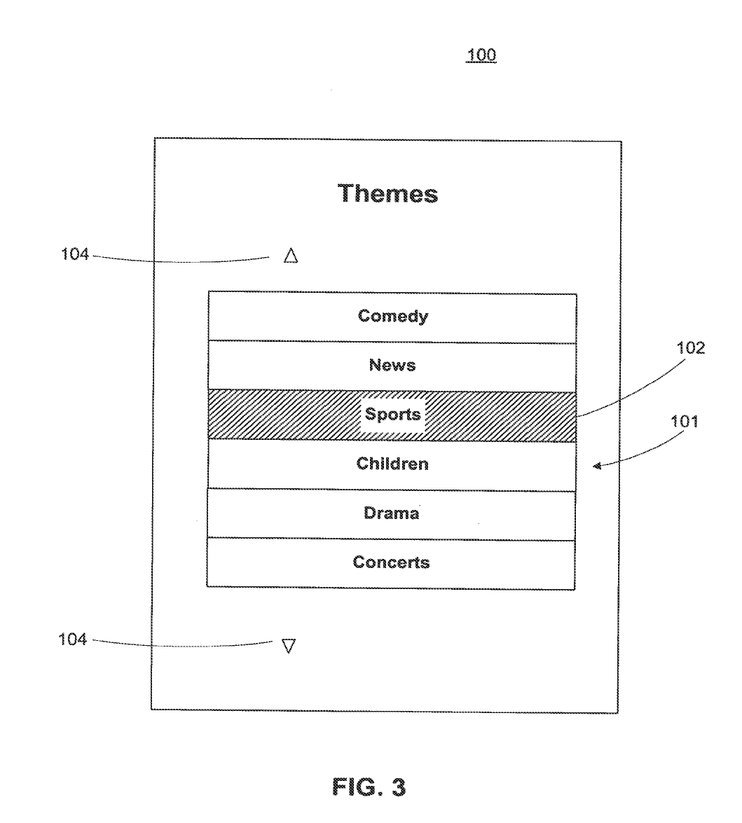

The process of selecting programming according to the invention is illustrated in FIG. 2. At step 39, the interactive program guide displays a list of available programming themes 101 (see, FIG. 3). At step 40, the user is provided with the option of modifying the list of themes in accordance with the user's viewing preferences. Typically, the user designates a favorite theme at this step, which indicates a generally high level of user interest. The themes list is modified based on that theme selection and level of interest. As will be described below, the themes list may be reordered to reflect the user's preference. Alternatively, particular themes in the themes list may be displayed in a distinctive manner to reflect the user's preference. At step 42, the user is provided with the option of designating a theme from the themes list as a search criterion for searching the program listings data. The user may select the favorite theme at this time or, alternatively, any other theme at step 42. At step 44, the user is provided with the option of viewing program listings which satisfy the selected search criteria.

Each of the above steps is independent of the preceding steps, such that the user may skip any of the steps during the process of selecting programming of interest. For example, the user may modify the themes list to the user's preference by designating favorites once at step 40. During subsequent viewings, the user may go directly to step 42 to select a theme from the themes list and skip step 40. During other viewings, the user may skip steps 40 and 42, and view programming listings at step 44. Moreover, steps 40 and 42 may be combined such that the user may concurrently designate a favorite theme and select that theme as a search criteria. As will be described herein, the user may execute each of steps 40, 42, and 44 in separate, interactive screens. In some embodiments, the steps may be combined in a single screen.

According to a first embodiment of the invention, the step of modifying the themes list and the step of designating a theme as a search criterion are performed in interactive themes selection screen 100, represented in FIG. 3. This screen may be invoked by selecting an OK or select button on the user remote control 34 to select an appropriate menu option in the program guide. The themes available are identified and displayed in a themes list 101 (see, FIG. 2, step 39). The themes may be listed alphabetically. Alternatively, the themes may be organized hierarchically with broader themes, such as “movies,” “sports,” etc. being further divided into more particular sub-themes “dramas” and “comedy,” or “football” and “golf,” respectively. Theme selection screen 100 permits the user to modify the themes list 101 (step 40) and to select a theme as a search criterion (step 42).

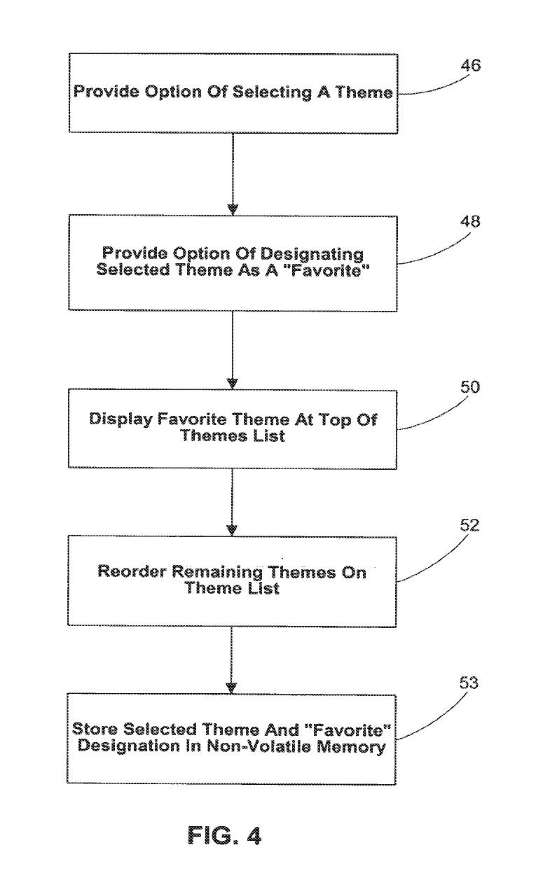

The step of modifying the themes list 101 is performed in the themes selection screen 100. More particularly, the user is able to designate a favorite theme and redisplay the themes list according to that favorite theme selection. By designating a favorite theme and reordering the themes list 101 accordingly, the themes list 101 becomes more useful in reflecting the user's viewing preferences. Modifying the themes list includes step 46 in FIG. 4, wherein the user is given the option to select a theme, e.g., by highlighting it. At step 48, the user is given the option to designate the theme as a favorite theme, i.e., indicative of a generally high level of user interest. When the user designates a theme as a favorite, that theme is displayed at the top of the themes list at step 50. At step 52, each of the remaining themes is shifted down within the themes list 101 by one position in order to accommodate the favorite in the first position.

The user may proceed through steps 46-52 repeatedly to make several favorite theme designations. Each time a new favorite theme is designated, it is placed at the top of the list, and the previous favorite is displayed immediately beneath the current favorite. After repeated designations of favorite themes, the themes displayed near the top of the list will be the user's most recent favorites. Consequently, programming selection is simplified because the user is required to scan down only a portion of the list to view themes that reflect the user's current viewing preferences.

With continued reference to FIG. 3, the designation of the favorite may be performed by the user at themes selection screen 100. The themes list 101 may have more entries than may fit on the theme selection screen 100, and cursor buttons 104 may be used to scroll upward or downward on the list. The user may select the highlighted theme 102 with the cursor buttons 104 on the screen or the cursor keys on the user remote control. Once the desired theme has been highlighted, it may be designated as a favorite by pressing the favorites button on the user remote control 34. Alternatively, the user may be provided with an option to directly type in a few letters of the theme rather than scroll through the entire list of themes with cursor buttons 104.

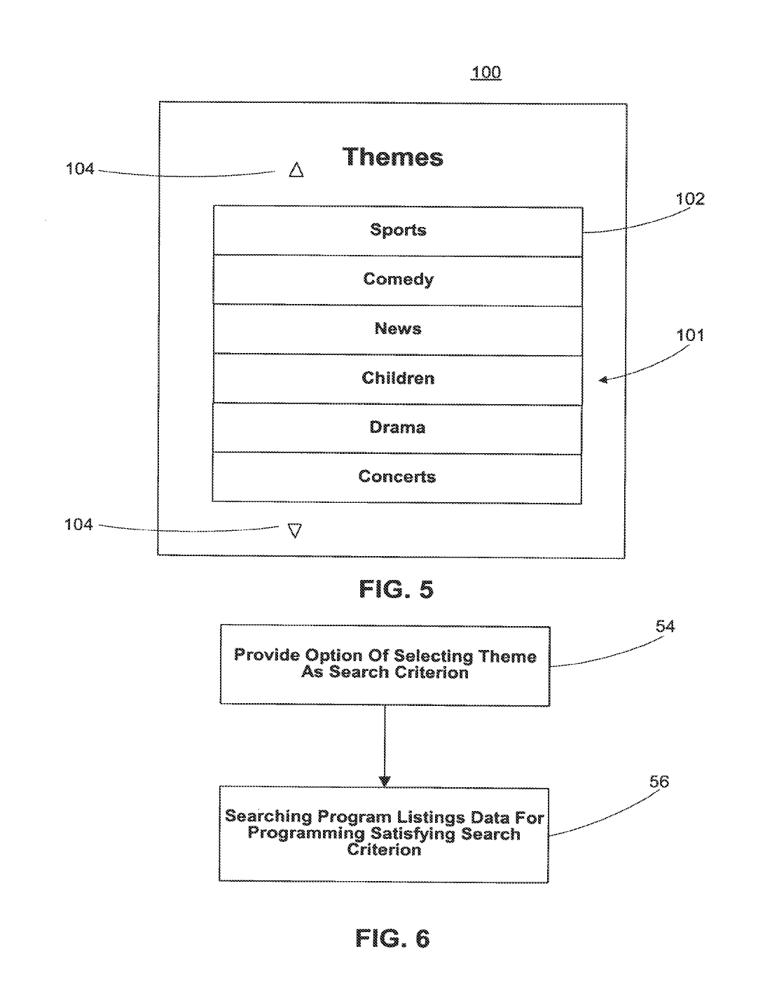

The reordered themes list 101 is shown at FIG. 5, with the favorite theme “sports” 102 at the top of the themes list. The remaining themes are moved down one position on the themes list to accommodate the favorite. The user is provided with the option of designating another favorite theme by highlighting that theme.

Modifying the themes list 101 to display favorite themes may be executed by the user infrequently, whereas the process of selecting particular themes and particular programming may be executed several times during each viewing session. Therefore, once the themes list has been modified to reflect the user's favorite themes, the process need not be repeated. The favorite themes are preferably stored in non-volatile memory, so that the display sequence will be remembered after power is cycled (step 53, FIG. 4).

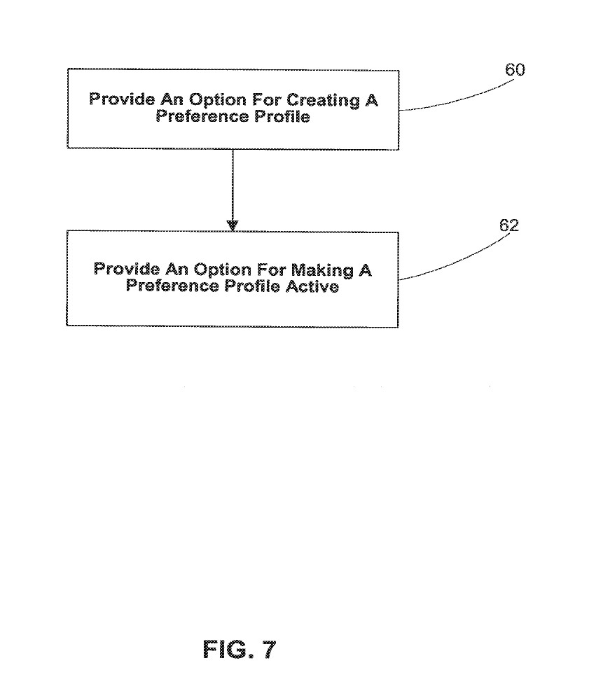

Themes information for a particular theme may include a designation of a high or a low level of interest, a position or ranking on the themes list, or an associated color or display icon. This themes information, along with any other modifications to the themes list, may be stored as a component of a preference profile, which maintains information of a user, such as account numbers, premium channels, etc. (see, for example, Ellis et al. U.S. patent application Ser. No. 09/034,934, filed Mar. 4, 1998, which is hereby incorporated by reference herein in its entirety). As illustrated in FIG. 7, the program guide provides the user with the option at step 60 to create a preference profile. If there are multiple users, a separate preference profile may be maintained for each user. The program guide may therefore provide the user with the option of making one of the profiles active at step 62. During use of the program guide, each user may invoke that user's own profile, and the program guide would then display the themes list according to that user's theme preferences.

With continued reference to FIG. 3, the step of selecting a theme as a search criterion (step 42) may be performed by using cursor keys on the user remote control or cursor buttons 104 on screen 100 to highlight a particular theme 102, i.e., “sports”. After the desired theme has been highlighted, the user presses select or OK on the user remote. Thus the theme “sports” has been selected as a search criterion for searching the program listings data for programming having the “sports” theme. As illustrated in FIG. 6, once a theme has been selected (step 54), the program guide searches the program listings data for any programming satisfying the search criterion (step 56). The search may be performed in database 29 by the user equipment 20 or 22 or in database 18 at television distribution facility 15 when a client-server architecture is used.

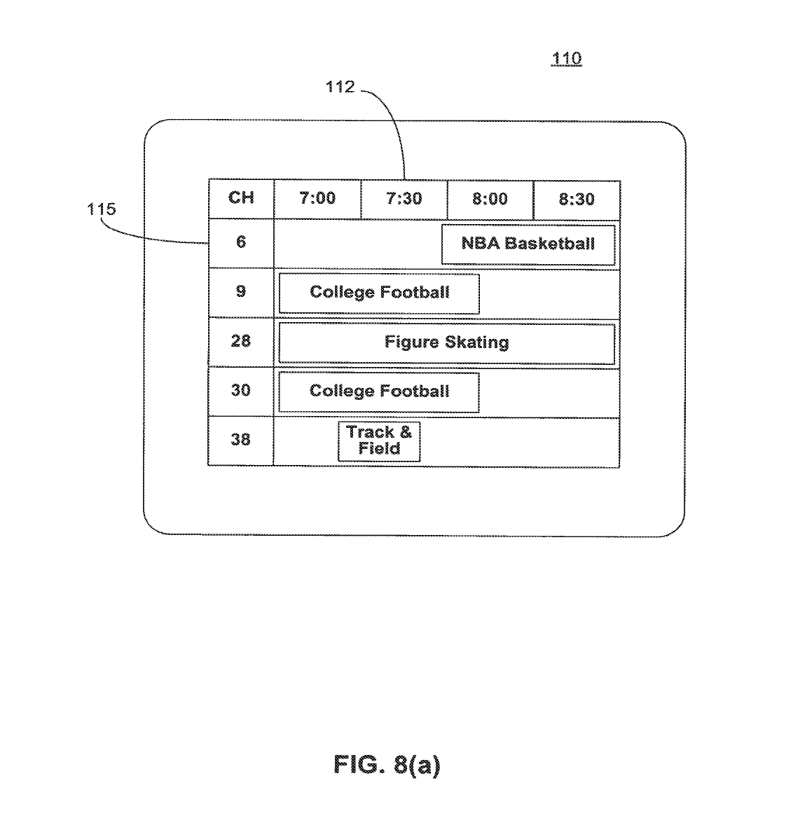

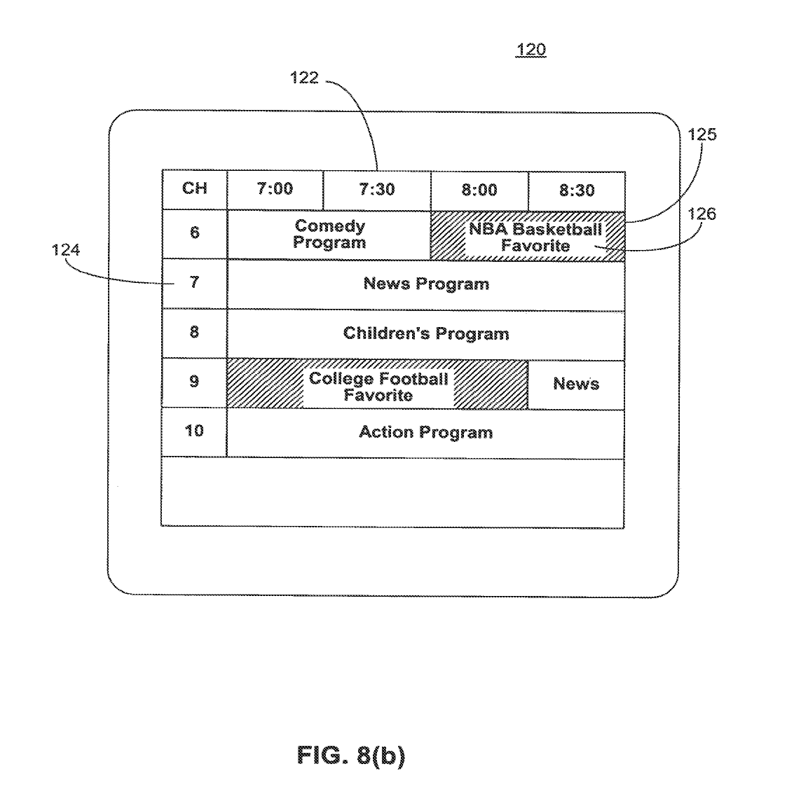

The user is provided the option of displaying the results of the search, i.e., the program listings that have the selected theme (see FIG. 2, step 44). A list of programming that has the selected theme is displayed according to one embodiment in FIG. 8(a). The listing 110 of programming is a by-time listing displayed by broadcast time 112 and by channel 114. Only programming having the selected theme is displayed, whereas program listings which do not have the selected theme are suppressed from view. In the current example, only programming which has the theme “sports” is displayed. According to a second embodiment (FIG. 8(b)), listing 120 displays all available programming to the user by broadcast time 122 and by channel 124. Blocks 125 containing programming which has the desired theme is distinctively displayed to attract the user's attention. For example, each program may be represented in a particular color. In addition, an icon or label 126, e.g., “favorite” may be provided in the programming block 125. Continuing with the example, all programming is displayed, but only programming having the “sports” theme is specially highlighted or displayed. The user may remain in the program listings mode (step 44) and make programming selections within this mode, as is known in the art. For example, the user may highlight a particular program to make a selection. While viewing listing 120, the user may quickly move the highlighted region between programs having the selected “favorite” theme and skip over all other programming. In one embodiment, by pressing a “FAV” key on the user remote 34, the viewer may advance the highlighted region from “NBA Basketball” on channel 6 directly to “College Football” on channel 9, while skipping channels 7-8. Alternatively, the user may be chose the option to select another theme (step 42), or to modify the themes list by designating another favorite (step 40).

According to a second embodiment, the step of modifying the themes list may also provide the user with the option of selecting a theme which is not a favorite, i.e., a theme for which the user has a generally low level of interest. Therefore, the display of that type of theme on the themes list 101 may distract the user from selecting programming of interest. Consequently, designating the theme as a non-favorite modifies the themes list so that a particular non-favorite theme is less prominently displayed or deleted from view.

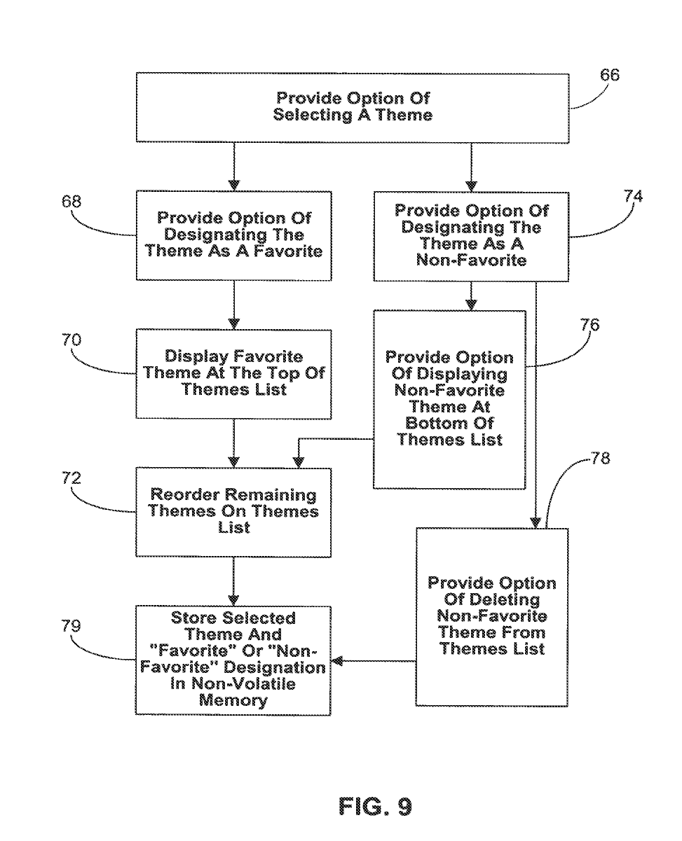

As illustrated in FIG. 9, the user is given the options of selecting a theme at step 66, and designating the theme as a favorite (step 68). The second embodiment according to the invention also provides the option at step 74 to select a theme as a non-favorite, i.e., indicating that the user has a generally low level of interest. As with steps 48-52, above, for designating favorite themes, the designation of non-favorite themes at step 74 may be performed repeatedly.

The user is subsequently provided with the option of selecting how the themes list will be modified by the designation of the non-favorite theme at step 74. Alternatively, the themes list may be modified according to a default setting, as will be described in greater detail below. In an exemplary default setting, the option may only be provided to the user during an initial set-up procedure, if at all. According to a first option (step 76), the non-favorite theme is displayed at the bottom of the themes list. Consequently, the user will not view that particular theme in the themes list during casual searching, unless the user chooses to scroll to the bottom of the list. (The remainder of the themes are reordered at step 72, as described above for favorites at step 70.)

Alternatively, at step 78, the user is given the option of deleting that theme from display on the themes list 101. For example, the user may have no interest in horror movies. Thus, the user may chose to remove the theme “horror” from the themes list 101. The theme which has been selected at step 66, and designated as a non-favorite at step 74, is deleted from the themes list at step 78. The deletion of a theme at step 78 is useful when there is expected to be so little interest in a particular theme that the user does not wish to be given the option of selecting programming having that theme.

As described above, the user preferences with respect to the themes and level of interest, i.e., “favorite” or “non-favorite” designation, are preferably stored in the non-volatile memory at step 79 so that information is not lost when the set-top box is shut down and restarted.

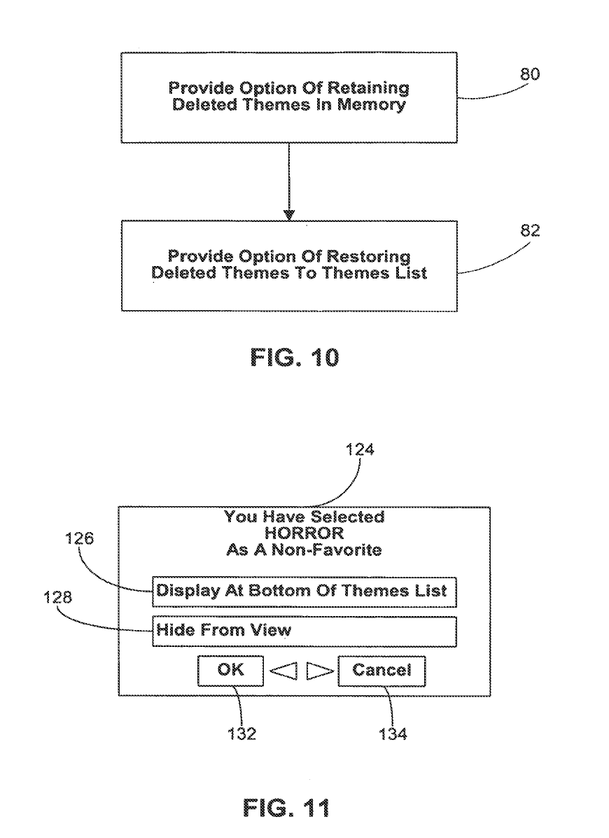

It is contemplated that the user's preferences may change, or that a plurality of users may have access to the program guide. Thus, at step 80 (FIG. 10), the user is given the option of retaining the deleted themes in the non-volatile memory. At step 82, the user may be provided with the option to restore the deleted themes to the themes list 101. The restoration process may global, such that all deleted themes are returned to the themes list 101. Alternatively, the restoration process of step 82 may be selective, wherein the user may view the deleted themes and restore individual themes to the themes list 101. It is contemplated that steps 80 and 82 may require the entry of personal identification code or other access code.

With continued reference to FIG. 3, selection of a non-favorite theme may be done by highlighting the theme 102 and then pressing the delete button on the user remote control 34. The program guide may have been programmed with a default option wherein the non-favorite theme is placed at the bottom of the themes list (see, FIG. 7, step 76). Alternatively, the default option may be to delete the selected theme from the themes list (step 78). According to yet another alternative, as shown in FIG. 10, the user may be prompted to select one of the two options when a theme is designated as a non-favorite. Accordingly, when a theme is highlighted and delete is selected, a window 124 is displayed to confirm the user's selection. The user is notified that the selection has been designated a non-favorite. In addition, the user is given the option of selecting option 126 to place the theme at the bottom of the list or option 128 to delete the theme from the themes list. The user may then select OK at option 132 to confirm the selection or CANCEL at option 134 to discontinue the selection.

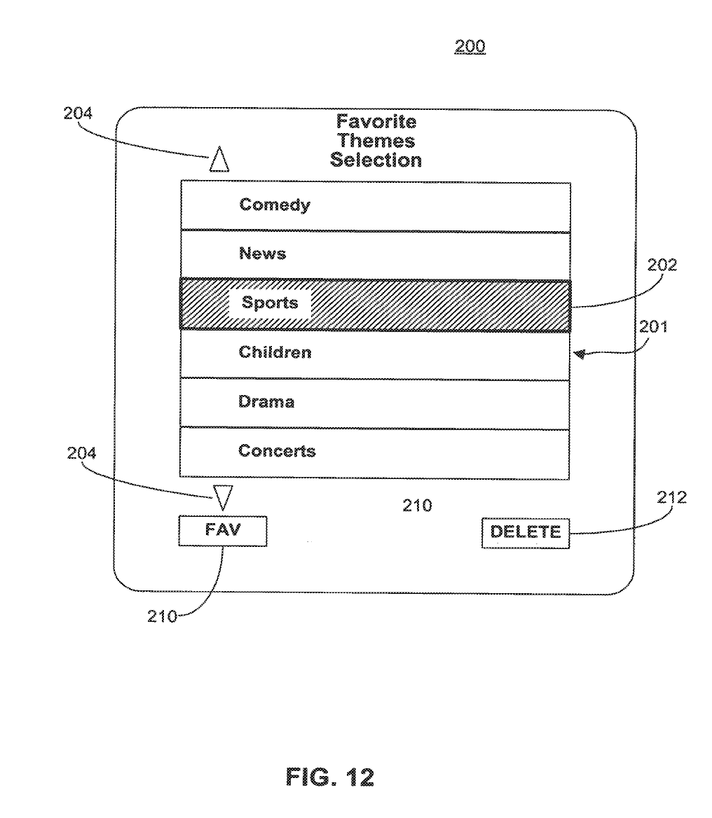

According to a third embodiment, the step of modifying the themes list by designating a favorite theme and reordering the themes list 101 (step 40) is accomplished with a first interactive screen 200 (FIG. 12). In contrast with the previous embodiments, the step of selecting a theme as a search criterion is accomplished in a separate, second interactive theme selection screen, such as screen 100 (FIG. 3).

As illustrated in FIG. 12, when screen 200 is invoked, the user is provided with a list of themes 201, and cursor buttons 204. In addition, FAV on-screen button 210 permits the user to designate favorite themes, and a DELETE on-screen button 212 permits the user to designate non-favorite themes. The user selects the particular theme, i.e., “sports” 202, from the themes list, for example by scrolling up and down the list with the arrow keys on the user remote or by highlighting and selecting the up and down-cursor buttons 204 on screen 200. The user then selects the theme by pressing select or OK on the user remote. When a theme is selected, it may be displayed in a “highlighted format,” e.g., by shading or an outline surrounding the block for theme 202.

The user is then provided the option of designating the selected theme as a favorite (step 68) or designating the selected theme as a non-favorite (step 74). To designate the selected theme as a favorite, the user may press the Favorites key on the user remote, as above. Alternatively, the user may highlight and select the FAV on-screen button 210. By designating a favorite, the themes list is modified as described above, i.e., the selected favorite is placed at the top of the themes list and the remaining themes are moved down by one position to accommodate the new favorite. To designate a non-favorite, the user presses the delete key on the user remote or highlights and selects the DELETE on-screen button 212. As described above, the user may select the option wherein the non-favorite theme is placed at the bottom of the themes list or alternatively is deleted from the themes list entirely. After modifying the themes list at screen 200, the user would be prompted to go to screen 100 to select a theme as a search criterion.

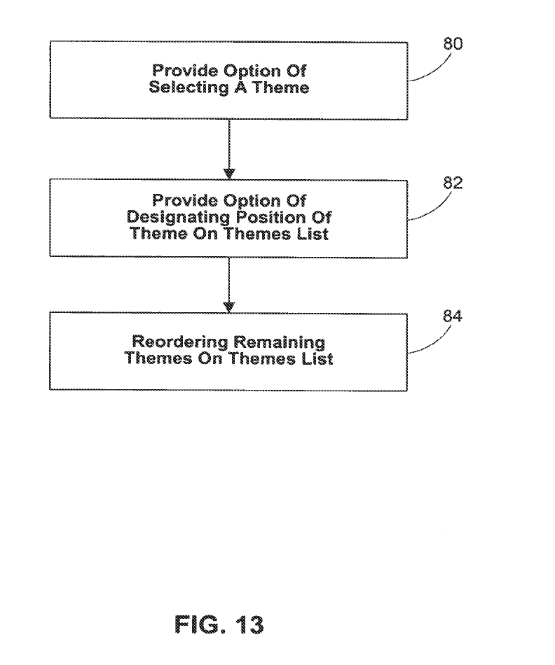

In an alternative embodiment, the user may be provided the option of modifying the display of themes with greater precision than described above. As illustrated in FIG. 13, after selecting a theme at step 80, the user is given the option at step 82 of selecting the position of a theme on the themes list. For example, the user may wish to place the theme in the second position, rather than at the top of the list. The themes list 101 displays the themes according to the selected order (step 84). Typically, a numerical ranking is associated with each theme. This numerical ranking may be displayed on the screen with the themes list, or it may be suppressed from the visual presentation, if desired.

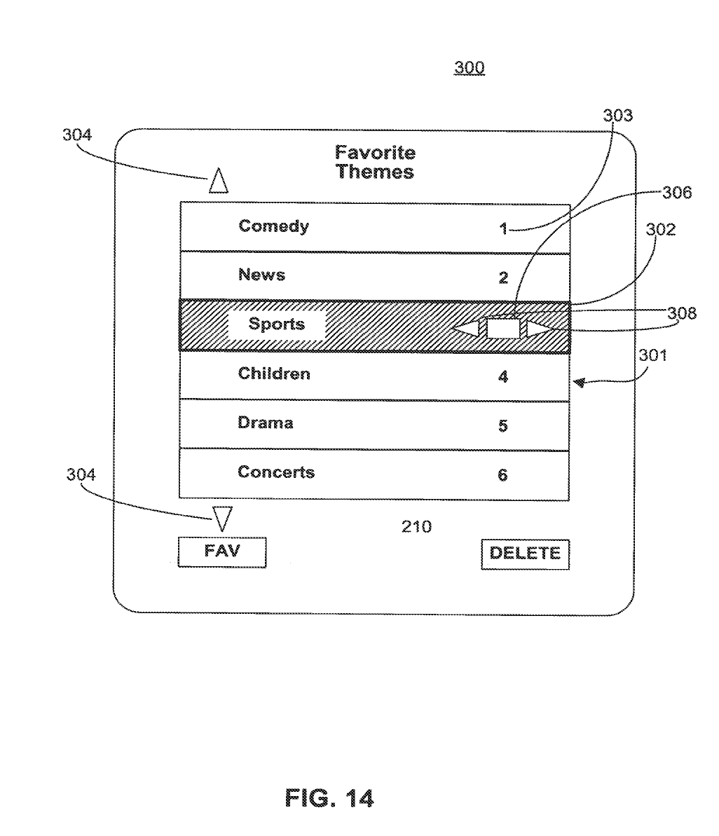

According to this embodiment, the favorite theme designation screen 300 (FIG. 14) provides the user with the option of providing a numerical position for the theme in the themes list 301. Upon selecting this option, the numerical position 303 of each theme in the themes list may be displayed. The user may highlight a particular theme using cursor buttons 304. The highlighted theme 302 is provided with a window 306 having a plurality of selection buttons 308 for changing the theme's position in the theme list. The selection window 306 provides the user with the option of directly inputting the numerical rank or position for that theme in the themes list. The remote control 34 may be provided with a numerical keypad. Alternatively, the user may be prompted to use cursor keys 308 to select a numerical position for the particular theme. It is understood that the various selection screens and keystrokes are merely illustrative of the invention.

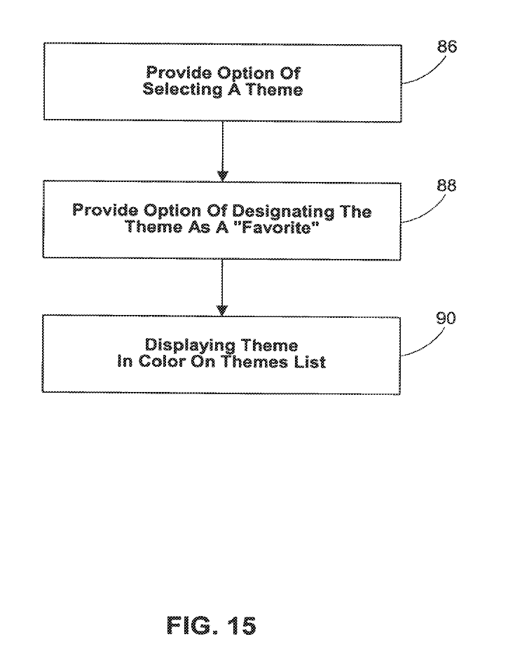

In another alternative embodiment, the user is provided with the option of displaying favorite themes in a distinctive color in order to assist the user in quickly identifying favorite themes. Moreover, this embodiment allows the user to designate several themes as favorites and search the program listings for programming having at least one of the several themes. At step 86, the user is provided with the option of selecting a theme, and at step 88 the user is provided the option of designating the theme as a favorite (FIG. 15). At step 90, the favorite theme is redisplayed on the themes list in color.

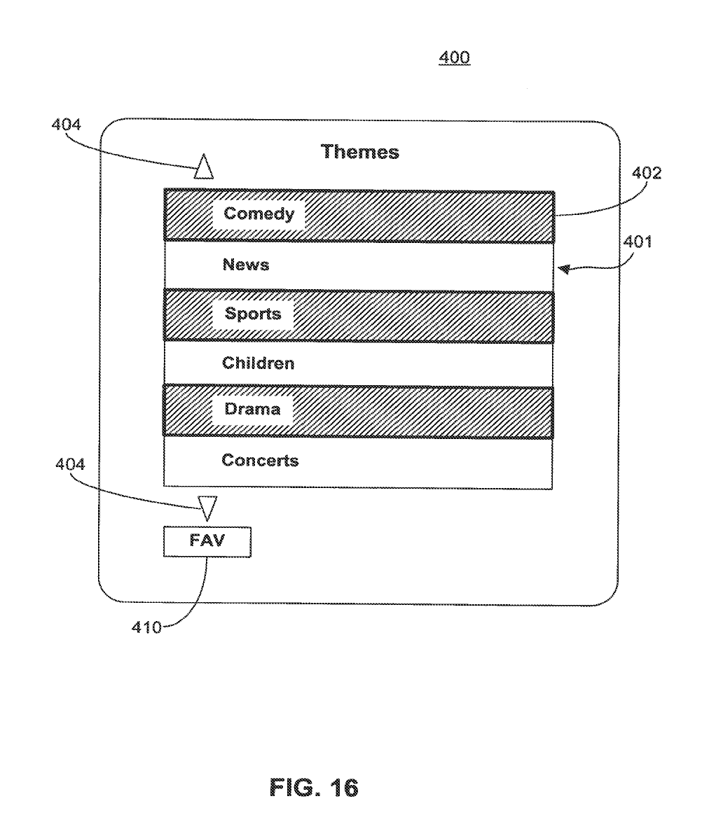

Theme selection screen 400 permits both the step of modifying the themes list (step 40) by designating and highlighting favorite themes and the step of designating the themes as search criteria (step 42). The user is provided with the option of selecting a theme by using the cursor keys 404 to scroll to the desired theme (FIG. 16). The user designates the highlighted theme as a favorite by pressing the Favorites button on the user remote or by highlighting and selecting the FAV on-screen button 410. In contrast with the embodiments described above, the designated favorite theme does not change location on the themes list 401 but is represented in a particular color. The user may be prompted to select a color, or a default color may be selected by the program guide to assign to all selected favorite themes. This process of designating themes may be repeated as many times as desired. The modified themes list continues to display all themes during this process. However, themes designated as favorites would be displayed in the selected color, and themes that the user has not selected will continue to be represented in a neutral color, such as white or black. In FIG. 16, for example, the user has designated “comedy,” “sports,” and “drama” as favorite themes 402.

Once the favorite themes have been designated, theme selection screen 400 permits the user to use the designated favorites as search criteria. By pressing select or OK on the user remote, the program guide performs a search in the program listings data wherein the selected themes would serve as search criteria for any programming having at least one of the designated favorite themes.

The user is then able to display a list of programming which includes any of the themes which have been selected. Such a display may be similar to program listing 110 (FIG. 8(a)), or program listing 120 (FIG. 8(b)). As described above, the user preferences with respect to the themes are preferably stored in the non-volatile memory so that information is not lost when the set-top box is shut down and restarted.

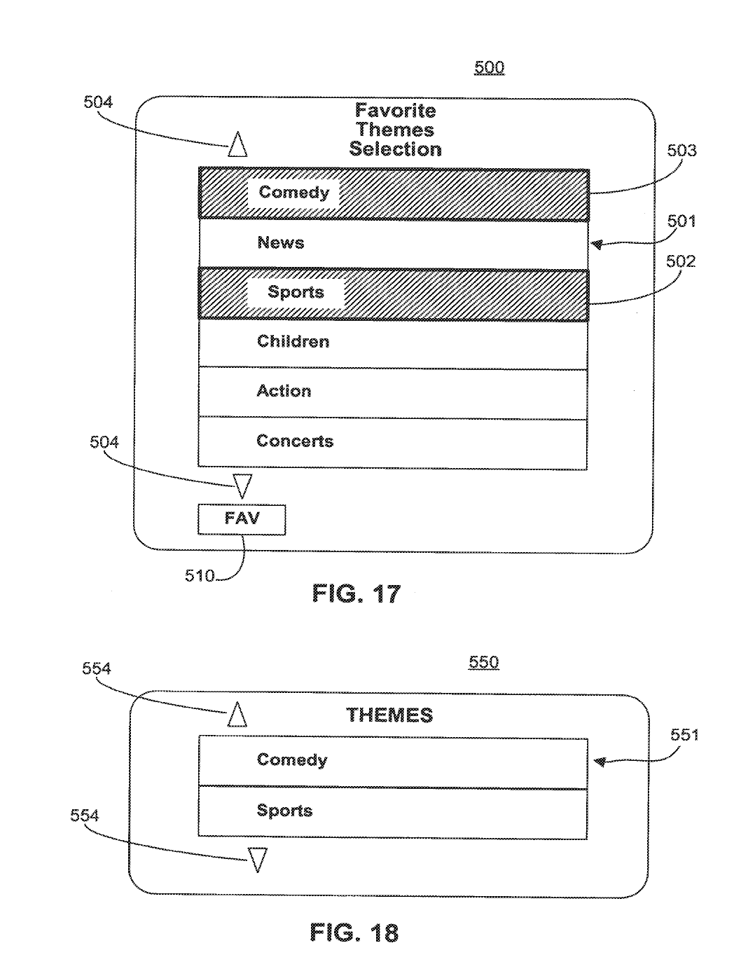

In yet another alternative embodiment, screen 500 is invoked, as illustrated in FIG. 17. Screen 500 is similar to screen 200, described above, in providing the option of modifying the themes list (step 40, FIG. 2). Likewise, the option of selecting a theme as a search criterion (step 42) is provided in a separate interactive screen. Screen 500 provides the user with a complete list of themes 501, and FAV on-screen buttons 510 that permit the user to designate several favorite themes. The user selects a theme, such as “sports” 502, from the themes list substantially as described above, for example, by scrolling up and down the list with the arrow keys on the user remote or by highlighting and selecting the up and down-cursor buttons 504 on screen 500. (In the exemplary embodiment, the selected theme is illustrated in a highlighted format, e.g., by the dark line surrounding block 502.) The user may designate the selected theme as a favorite by pressing Favorite on the user remote, or highlighting and selecting the FAV button 510 on screen 500. Each time a theme is selected and designated a favorite, it may be distinctively displayed, for example, in a predetermined color (as illustrated by the shading in the FIG.) or accompanied by an icon or label to indicate its status as a favorite. As with the embodiment described with respect to FIG. 16, the process of designating favorite themes may be repeated as many times as desired. In FIG. 17, the theme “comedy” 503 has also been selected as a favorite theme and is displayed in a predetermined color. The modified themes list continues to display the complete list of themes on screen 500, with favorite themes distinctively displayed as described above. The user may exit screen 500 by pressing select or OK on the user remote.

Screen 550, as illustrated in FIG. 18, may be displayed after the user has designated at least one favorite theme in screen 500. Screen 550 may also be reached from other interactive screens described above. Screen 550 displays a partial themes list 551, which is substantially similar to themes list 101 described above. However, themes list 551 is modified to display themes designated as favorites. Continuing with the above example, themes “comedy” and “sports” were selected as favorites in screen 500. All other themes not previously selected may be deleted or suppressed from view. The selection of programming is thereby simplified for the user by the display of favorite themes only. From screen 550, a theme may be selected as a search criterion by highlighting the theme and pressing select or OK on the user remote. As described with respect to FIG. 6, once a theme has been selected (step 54), the program guide searches the program listings data for any programming satisfying the search criterion (step 56). The results of the search may be displayed as in FIG. 8(a) or 8(b), described above, or other similar format.

The user's preferences with respect to favorite themes may change over time. The user may wish to change the selection of favorite themes that are displayed at screen 550 by for example, highlighting and selecting the up and down cursor buttons 554 on screen 550. At step 80 (FIG. 10), the user is provided with the option of retaining in memory the themes which were not selected at screen 500 and deleted from themes list 551. This process may alternatively be a default setting, such that the option is provided to the user during a set-up procedure, if at all. At step 82, the user may be provided with the option of restoring deleted themes to the themes list at screen 500.

The foregoing is merely illustrative of the principles of this invention and various modifications can be made by those skilled in the art without departing from the scope and spirit of the invention.

1-106. (canceled)

107. A method for using an interactive media guidance system in which an interactive media guidance application is at least partially implemented on user equipment of a user, comprising:
displaying a default list of hierarchically organized programming themes and programming sub-themes;
receiving, using a processor, a selection of at least one of the programming themes and at least one of the programming sub-themes from the default list of hierarchically organized programming themes and programming sub-themes and an indication of interest in each of the selected programming themes and programming sub-themes; and
displaying a user list of programming themes including the selected at least one of the programming themes and selected at least one of the programming sub-themes, wherein all of the selected programming themes and programming sub-themes are displayed in a single hierarchical level.

108. The method of claim 107, further comprising alternating between displaying the default list of hierarchically organized programming themes and programming sub-themes and the user list of programming themes.

109. The method of claim 107, further comprising searching listings data for programming satisfying a search criterion in response to selecting as the search criterion at least one of the programming themes and programming sub-themes.

110. The method of claim 109 further comprising displaying a list of the programming satisfying the search criterion.

111. The method of claim 107, wherein the programming themes are broad categories and the programming sub-themes are narrower categories that have common differentiating characteristics within the programming themes.

112. The method of claim 107, wherein the receiving the indication comprises receiving a designation of a high level of interest in the each of the selected at least one of the programming themes and the selected at least one of the programming sub-themes.

113. The method of claim 107, wherein each of the selected at least one of the programming themes and selected at least one of the programming sub-themes are marked with a color.

114. The method of claim 107, wherein each of the selected at least one of the programming themes and selected at least one of the programming sub-themes are displayed with an icon.

115. The method of claim 107, further comprising ordering all of the selected at least one of the programming themes and selected at least one of the programming sub-themes in the user list based on the indication of interest in each of the selected programming themes and programming sub-themes

116. The method of claim 107, further comprising storing the user list as a part of a user preference profile.

117. An interactive media guidance system in which an interactive media guidance application is at least partially implemented on user equipment of a user, comprising:
a processor configured to:
receive a selection of at least one of a programming themes and at least one of the programming sub-themes from a default list of hierarchically organized programming themes and programming sub-themes, and
receive an indication of interest in each of the selected programming themes and programming sub-themes;
a monitor configured to:
display a default list of hierarchically organized programming themes and programming sub-themes, and
display a user list of programming themes including the selected at least one of the programming themes and selected at least one of the programming sub-themes, wherein all of the selected programming themes and programming sub-themes are displayed in a single level.

118. The system of claim 117, wherein the processor is further configured to alternate between displaying the default list of hierarchically organized programming themes and programming sub-themes and the user list of programming themes.

119. The system of claim 117, wherein the processor is further configured to search listings data for programming satisfying a search criterion in response to selecting as the search criterion at least one of the programming themes and programming sub-themes.

120. The system of claim 119, wherein the monitor is further configured to display a list of the programming satisfying the search criterion.

121. The system of claim 117, wherein the programming themes are broad categories and the programming sub-themes are narrower categories that have common differentiating characteristics within the programming themes.

122. The system of claim 117, wherein the processor is further configured to receive a designation of a high level of interest in the each of the at least one selected programming themes and programming sub-themes.

123. The system of claim 117, wherein each of the selected at least one of the programming themes and selected at least one of the programming sub-themes are marked with a color.

124. The system of claim 117, wherein each of the selected at least one of the programming themes and selected at least one of the programming sub-themes are displayed with an icon.

125. The system of claim 117, further comprising a memory configured to order all of the selected at least one of the programming themes and selected at least one of the programming sub-themes in the user list based on the indication of interest in each of the at least one selected programming themes and programming sub-themes.

126. The system of claim 117, further comprising a memory configured to store the user list as a part of a user preference profile.
